(19) United States
(12) Patent Application Publication
(10) Pub. No.: US 2015/0309339 A1
(43) Pub. Date: Oct. 29, 2015

(54) TUNABLE OPTICAL FILTER AND TUNABLE OPTICAL FILTER MODULE

(71) Applicant: National Tsing Hua University, Hsinchu City (TW)

(72) Inventors: I-Te Yu, Hsinchu City (TW); Yi-Hsin Chen, Kaohsiung City (TW)

(21) Appl. No.: 14/329,993

(22) Filed: Jul. 14, 2014

(30) Foreign Application Priority Data
Apr. 24, 2014 (TW) 103114829

(51) Int. Cl. G02F 1/01

(52) U.S. Cl. CPC G02F 1/0147

(57) ABSTRACT

A tunable optical filter with an optical axis is provided. An input light field moves forward from an upstream end to a downstream end, and passes through the tunable optical filter to form an output light field. The input light field has a main frequency range and a sub-frequency range, and the output light field has the main frequency range. The tunable optical filter includes an optical filtering element and a temperature controlling assembly. The optical filtering element has a lens body, a first and second coating films. A resonant cavity with a cavity length is formed inside the lens body. The temperature controlling assembly is thermally connected with the optical filtering element. The temperature controlling assembly controls the temperature of the optical filtering element to adjust the cavity length, so as to select the main frequency range. A tunable optical filter module having the tunable optical filter is provided.

### CROSS-REFERENCE TO RELATED APPLICATION

This application claims the priority benefit of Taiwan application serial no. 103114829, filed on Apr. 24, 2014. The entirety of the above-mentioned patent application is hereby incorporated by reference herein and made a part of this specification.

### BACKGROUND

1. Technical Field

The disclosure relates to an optical filter and an optical filter module, and particularly relates to a tunable optical filter and a tunable optical filter module.

2. Related Art

Optical filter has a wide range of application, and can be applied in optical communication, basic optics, quantum secure communication, and atomic and molecular physics research, etc., where the quantum secure communication is a novel secure communication technique, by which a principle of quantum mechanics is used to encrypt transmitted data, which has features of high efficiency and absolute security.

Along with booming development of optical communication industry and cloud computation technology, a new fourth-generation long term evolution (4G LTE) technique is developed, and the research of related equipment, product and techniques of the optical communication industry becomes more important.

Optical filters play an important role in the optical communication industry. The optical communication is to transmit data through light field, and has a characteristic of high transmission amount. In detail, the optical communication is to simultaneously transmit a plurality of channels with similar wavelengths in a same optical fiber, so as to achieve the high transmission amount. Then, the optical filter is used to separate the channels with similar wavelengths to different optical fibers.

Further, the optical filter can be applied in a frequency division multiplexing access (FDMA) technique, and the optical filter is used to divide a full bandwidth into a plurality of channels with equal bandwidths, and each channel is provided to one subscriber for usage. Therefore, if a frequency dividing capability of the optical filter is improved (i.e. having a narrow bandwidth characteristic), more channels can be provided to more subscribers for usage.

Taiwan Patent No. 1238269 discloses a Fabry-Perot optical filter device, by which the light field repeatedly passes through the same Fabry-Perot optical filter device to decrease a main frequency bandwidth and decrease a cross-talk effect. However, as the light field repeatedly passes through the same Fabry-Perot optical filter device, a light transmission having the main frequency is decreased.

As described above, how to obtain an optical filter having a narrow bandwidth characteristic, a good frequency stability, and a high transmission of the light having the main frequency is important in the development of the optical filter.

### SUMMARY

Accordingly, the disclosure is directed to a tunable optical filter and a tunable optical filter module, by which a main frequency range of light passing through the tunable optical filter is selected through temperature control, so as to achieve characteristics of narrow bandwidth, good frequency stability, high transmission of the main frequency range and high attenuation of a sub-frequency range.

The disclosure provides a tunable optical filter having an optical axis. An input light field moves forward from an upstream end to a downstream end of the optical axis, and passes through the tunable optical filter to form an output light field. The input light field has a main frequency range and a sub-frequency range, and the output light field has the main frequency range. The tunable optical filter includes an optical filtering element and a temperature controlling assembly. The optical filtering element has a lens body, a first coating film, and a second coating film, where the first coating film and the second coating film are respectively disposed on a first surface and a second surface of the lens body opposite to each other. A resonant cavity with a cavity length is formed inside the lens body. The temperature controlling assembly is thermally connected with the optical filtering element. The temperature controlling assembly controls the temperature of the optical filtering element to adjust the cavity length, so as to select the main frequency range.

The disclosure provides a tunable optical filter module including the aforementioned tunable optical filter, a light incident assembly, and a light receiving assembly. The light incident assembly is disposed on the optical axis, and guides the input light field to enter the tunable optical filter. The light receiving assembly is disposed on the optical axis, and the light receiving assembly receives the output light field from the tunable optical filter.

In an embodiment of the disclosure, in the tunable optical filter, along a direction from the upstream end to the downstream end of the optical axis, the temperature controlling assembly sequentially includes a heat dissipation structure, a temperature control chip, a thermal conduction body, a thermal conduction cover, and a light shielding cover, where the thermal conduction body has a space for accommodating the optical filtering element, and the optical filtering element is disposed between the thermal conduction body, and the thermal conduction cover.

In an embodiment of the disclosure, the tunable optical filter further includes a thermal conduction medium disposed between the optical filtering element, the thermal conduction body and the thermal conduction cover.

In an embodiment of the disclosure, the thermal conduction body has at least one thermistor.

In an embodiment of the disclosure, the heat dissipation structure, the temperature control chip, the thermal conduction body, the thermal conduction cover, and the light shielding cover respectively have a hole at a central portion, such that the input light field is capable of moving forward along the optical axis to pass through the optical filtering element to form the output light field.

In an embodiment of the disclosure, the tunable optical filter further includes a base, and the optical filtering element and the temperature controlling assembly are disposed on the base.

In an embodiment of the disclosure, in the tunable optical filter module, along a direction from the upstream end to the downstream end of the optical axis, the light incident assembly sequentially includes a first single mode fiber, a first collimating lens, and a first focusing lens.

In an embodiment of the disclosure, the light incident assembly further includes a focus adjusting mechanism of the input light field, and the first single mode fiber, the first collimating lens, and the first focusing lens are disposed on the focus adjusting mechanism, where the selections of a numerical aperture of the first single mode fiber, focal length of the first collimating lens, and focal length of the first focusing lens are used for adjusting a focus size of the input light field.

In an embodiment of the disclosure, the focus adjusting mechanism of the input light field includes a rotation platform and a translation platform for adjusting a focus position of the input light field.

In an embodiment of the disclosure, in the tunable optical filter module, along a direction from the upstream end to the downstream end of the optical axis, the light receiving assembly sequentially includes a first mirror, a second mirror, a second focusing lens, a second collimating lens, and a second single mode fiber.

According to the above descriptions, in the tunable optical filter and the tunable optical filter module of the disclosure, the cavity length of the resonant cavity of the double-side coated filtering element is adjusted through temperature control, so as to select the main frequency range, and accordingly achieve characteristics of narrow bandwidth, good frequency stability, high transmission of the main frequency range and high attenuation of the sub-frequency range. Moreover, the tunable optical filter has high flexibility, namely, the main frequency range, the filtering frequency and the attenuation of the sub-frequency range can all be adjusted. In addition, the tunable optical filter adopts a modular design to achieve high technique scalability.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is an exploded view of a tunable optical filter according to an embodiment of the disclosure.

FIG. 2 is a schematic diagram of the tunable optical filter of FIG. 1 after various components are assembled.

FIG. 3 is a schematic diagram of a filtering function of an optical filtering element of FIG. 1.

FIG. 4 is a schematic diagram of a tunable optical filter module according to an embodiment of the disclosure.

FIG. 5A is a spectrum diagram of an input light field passing through the tunable optical filter and passing through a light receiving assembly.

FIG. 5B is a spectrum diagram of a free spectrum range.

FIG. 5C is a spectrum diagram of full width at half maximum (FWHM) of a main frequency.

FIG. 6 is a schematic diagram of a linear relationship between a main frequency and temperature.

FIG. 7A is a schematic diagram of intensity (transmission) fluctuation of an output light field within 8 minutes.

FIG. 7B is a schematic diagram of intensity (transmission) fluctuation of an output light field within 1 second.

FIG. 7C is a schematic diagram of intensity (transmission) fluctuation of an output light field within 10 microseconds.

FIG. 8 is a schematic diagram of an optical communication system using a tunable optical filter of the disclosure as a demultiplexer.

### DETAILED DESCRIPTION OF DISCLOSED EMBODIMENTS

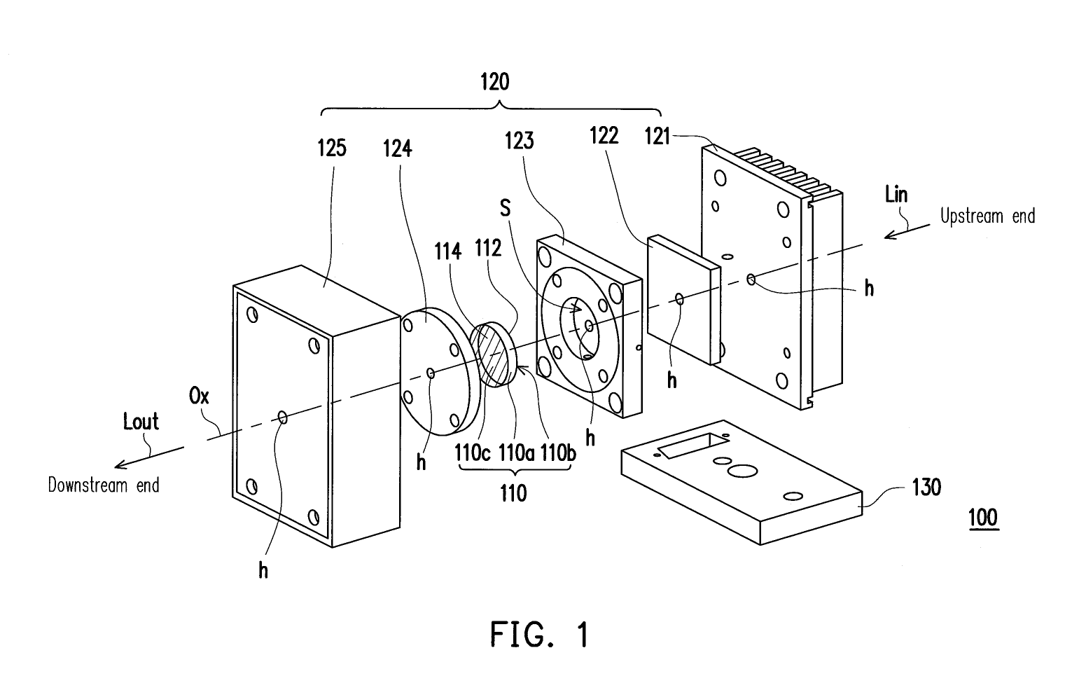

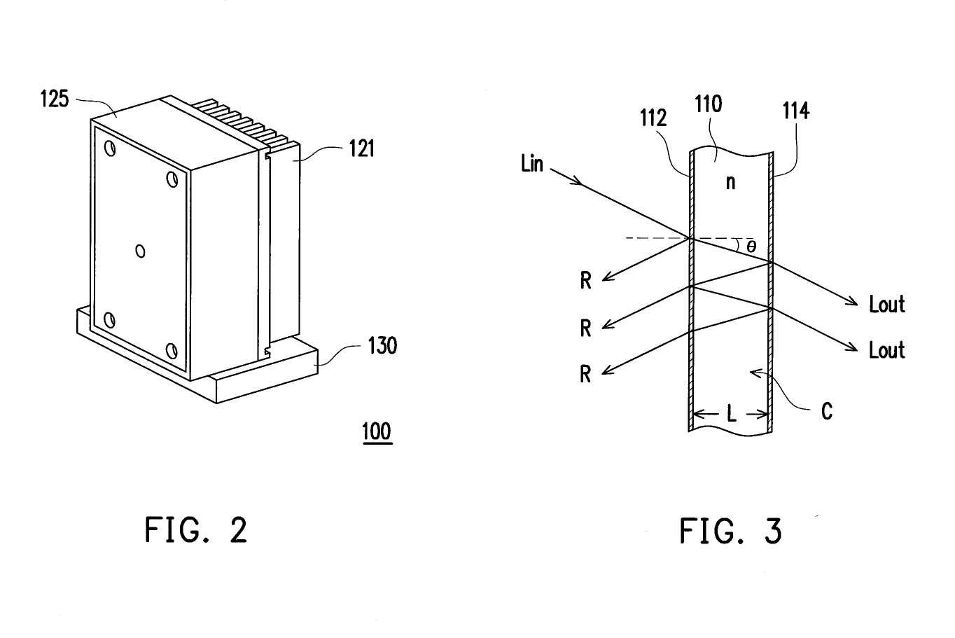

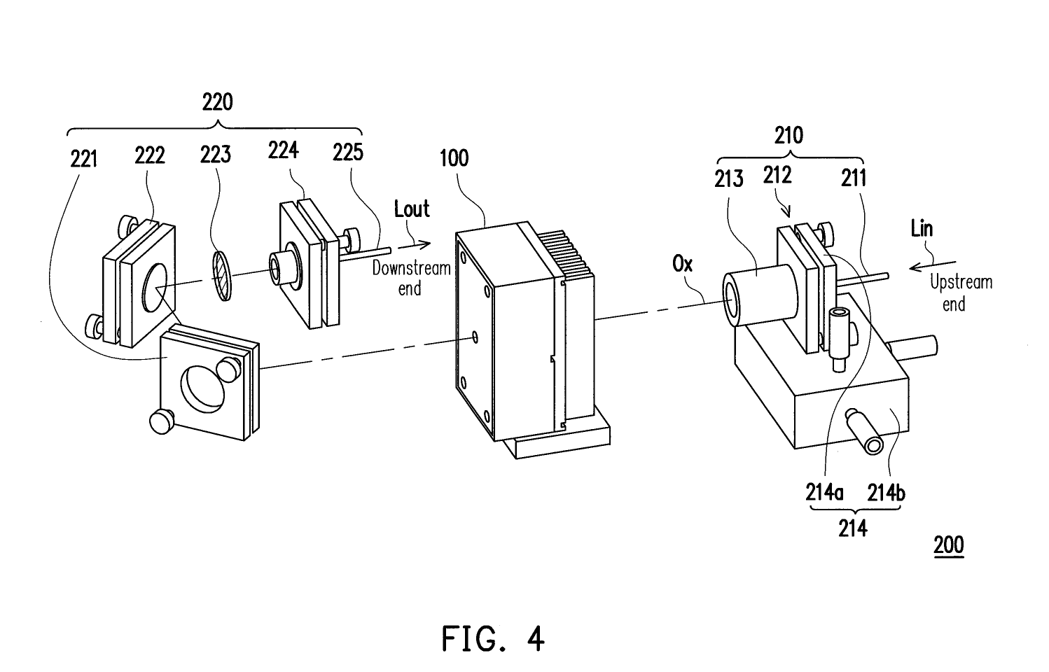

FIG. 1 is an exploded view of a tunable optical filter according to an embodiment of the disclosure. FIG. 2 is a schematic diagram of the tunable optical filter of FIG. 1 after various components are assembled. FIG. 3 is a schematic diagram of a filtering function of an optical filtering element of FIG. 1. Referring to FIG. 1-FIG. 3, an implementation of the tunable optical filter provided by the disclosure is introduced below.

Referring to FIG. 1-FIG. 3, the tunable optical filter 100 has an optical axis Ox. An input light field Lin moves forward from an upstream end to a downstream end of the optical axis Ox, and passes through the tunable optical filter 100 to form an output light field Lout. The input light field Lin has a main frequency range and a sub-frequency range, and the output light field Lout has the main frequency range. The tunable optical filter 100 includes an optical filtering element 110 and a temperature controlling assembly 120.

The optical filtering element 110 has a lens body 110a, a first coating film 110b, and a second coating film 110c. The first coating film 110b and the second coating film 110c are respectively disposed on a first surface 112 and a second surface 114 of the lens body 110a opposite to each other. A resonant cavity C with a cavity length L is formed inside the lens body 110a. The temperature controlling assembly 120 is thermally connected with the optical filtering element 110. The temperature controlling assembly 120 controls the temperature of the optical filtering element 110 to adjust the cavity length L, so as to select the main frequency range.

Referring to FIG. 1 and FIG. 3, first, the structure and operation principle of the optical filtering element 110 are introduced. As shown in FIG. 3, a refractive index of the lens body 110a is “n”, and the lens body 110a has the cavity length L. The incident light field Lin enters the optical filtering element 110 with an incident angle θ. The incident light field Lin is repeatedly reflected between the first coating film 110b and the second coating film 110c of the optical filtering element 110, and when the transmitted light field within the lens body 110a matches the constructive interference condition, the output light field Lout has the maximum transmission (the main frequency range). Moreover, as shown in FIG. 3, the incident light field R with the sub-frequency range is reflected and filtered by the optical filtering element 110.

In an embodiment, a laser light source of 780 nm can be used, and the first coating film 110b and the second coating film 110c can be fabricated with high reflection coating of 745 nm-825 nm. Though the disclosure is not limited thereto, and in case of different light sources, a wavelength range of the first coating film 110b and the second coating film 110c can be changed according to an actual requirement. The lens body 110a can be a plano-convex lens, a biconvex lens, or a concave-convex lens. Various parameters of the lens body 110a are as follows: a thickness is 4.3 mm, a surface flatness <λ/10 (where λ is the wavelength of the input light field Lin), a surface scratch/dig is 10/5, a diameter is 1 inch, a radius of curvature is 40.7 mm, and a material is optical glass (BK7). The above parameters of the lens body 110a are only used as an example, and are not used to limit the implementation of the disclosure. Reflectivity of the first coating film 110b and the second coating film 110c reaches 98%.

Referring to FIG. 1, an implementation of the temperature controlling assembly 120 is introduced below. In an embodiment, along a direction from the upstream end to the downstream end of the optical axis Ox, the temperature controlling assembly 120 sequentially includes a heat dissipation structure 121, a temperature control chip 122, a thermal conduction body 123, a thermal conduction cover 124, and a light shielding cover 125, where the thermal conduction body 123 has a space S for accommodating the optical filtering element 110, and the optical filtering element 110 is disposed between the thermal conduction body 123 and the thermal conduction cover 124.

As shown in FIG. 1, the heat dissipation structure 121 has a plurality of cooling fins to increase a heat dissipating area. The heat dissipation structure 121 can be made of copper having a good heat dissipation characteristic. Moreover, the heat dissipation structure 121 may have installation portions (for example, holes at four corners of the heat dissipation structure 121 shown in FIG. 1) to facilitate assembling various components by using screws.

The temperature control chip 122 can perform a heating operation or a cooling operation. A working voltage of the temperature control chip 122 is, for example, 15.5 Volt., a working current thereof is, for example, 7.9 Amp., a range of temperature difference is, for example, 69° C., and a cooling power is, for example, 75 Watt.

The thermal conduction body 123 can be made of aluminium. The thermal conduction body 123 may have installation portions at periphery (for example, four holes at periphery of the thermal conduction body 123 shown in FIG. 1). In an embodiment, the thermal conduction body 123 may further have at least one thermistor (not shown), which is used for measuring temperature to serve as a temperature reference of a temperature controller and an external monitoring temperature.

Moreover, two thermistors can be disposed on the thermal conduction body 123, and one of the measured temperatures serves as the temperature reference of the temperature controller, and another one serves as the external monitoring temperature. The resistance of the thermistor is, for example, 10 kΩ. It should be noticed that the thermal conduction body 123 has the space S for accommodating the optical filtering element 110. A shape of the space S can be matched to a shape of the optical filtering element 110, such that the optical filtering element 110 can be stably fixed to the thermal conduction body 123.

A central portion of the thermal conduction cover 124 can protrude out to contact the optical filtering element 110. In an embodiment, a thermal conduction medium (not shown) can be disposed between the optical filtering element 110, the thermal conduction body 123, and the thermal conduction cover 124. The thermal conduction medium is, for example, a thermal conductive silicon. In this way, a thermal contact performance between the optical filtering element 110, the thermal conduction body 123, and the thermal conduction cover 124 are enhanced by using the thermal conduction medium.

The light shielding cover 125 may adopt an opaque black acrylic cover. The light shielding cover 125 may isolate the external temperature and air disturbance to improve temperature stability of the optical filtering element 110. Moreover, the light shielding cover 125 can also block the external background light to reduce interference of the external background light.

Referring to FIG. 1, the heat dissipation structure 121, the temperature control chip 122, the thermal conduction body 123, the thermal conduction cover 124, and the light shielding cover 125 respectively have a hole h at a central portion, such that the input light field Lin is capable of moving forward along the optical axis Ox to pass through the optical filtering element 110 to form the output light field Lout.

In an embodiment, the tunable optical filter 100 may further include a base 130, and the optical filtering element 110 and the temperature controlling assembly 120 are all disposed on the base 130. The base 130 can be fixed to the bottom of the heat dissipation structure 121. Moreover, as shown in FIG. 1, a trapezoidal hole located to a left side of the base 130 may accept a connector having pins, so as to connect the temperature controlling assembly 120 to an external temperature controller (not shown).

Referring to FIG. 1, the double-side coated resonant cavity structure of the optical filtering element 110 is transparent to the input light field Lin with a specific frequency (the main frequency range), and filters the light field with other frequencies (the sub-frequency range). A difference between the main frequency and the sub frequency can be 10.7 GHz, namely, the optical filtering element 110 has a good filtering efficiency.

Moreover, the temperature controlling assembly 120 can select the main frequency range of the input light field Lin and can stabilize the power of the output light field Lout. The thickness of the lens body 110a is controlled by changing the temperature, and the cavity length L of the resonant cavity C is accordingly adjusted within a small range, so as to adjust a resonant frequency and to select a filtering range. Generally, the filtering range is inversely proportional to the thickness of the lens body 110a.

According to the above descriptions, the tunable optical filter 100 of the invention is a bandpass optical filter with a bandwidth of 150 MHz full width at half maximum (FWHM), and the bandwidth is thousands times smaller compared to the bandpass filter sold in the market. Moreover, the main frequency range is selected by using the temperature, and the lens body 110a includes the first coating film 110b and the second coating film 110c (a high reflection lens with reflectivity>98%), and the resonant cavity C is formed inside the lens body 110a, by changing the cavity length L between the two reflection surfaces, a resonant frequency is adjusted.

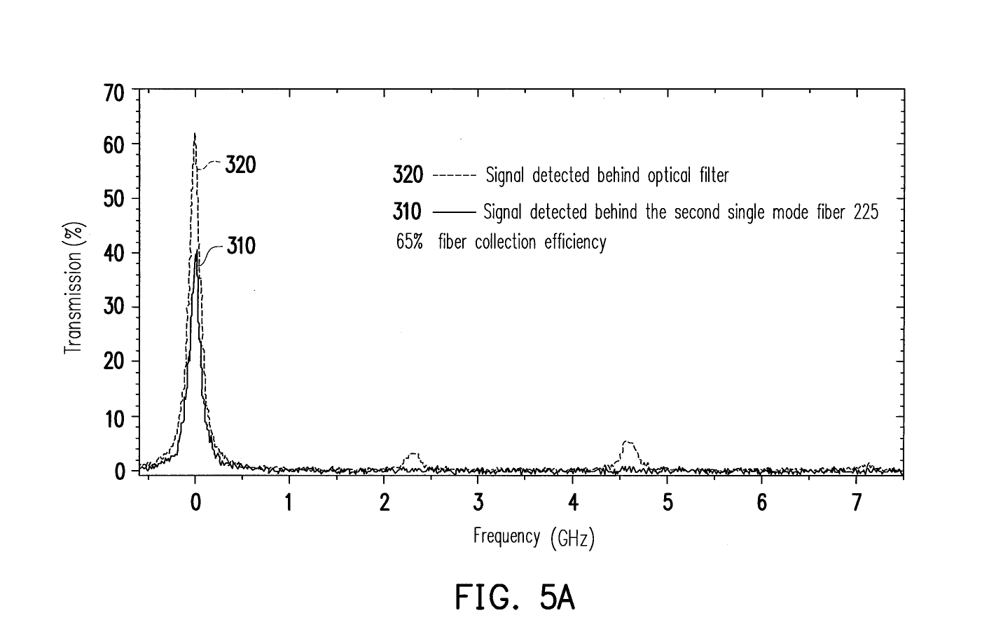

FIG. 4 is a schematic diagram of a tunable optical filter module according to an embodiment of the disclosure. The tunable optical filter module 200 includes the tunable optical filter 100 of FIG. 1, a light incident assembly 210 and a light receiving assembly 220. The light incident assembly 210 is disposed on the optical axis Ox, and guides the input light field Lin to enter the tunable optical filter 100. The light receiving assembly 220 is disposed on the optical axis Ox, and the light receiving assembly 220 receives the output light field Lout from the tunable optical filter 100.

Referring to FIG. 4, in the tunable optical filter module 200, along a direction from the upstream end to the downstream end of the optical axis Ox, the light incident assembly 210 sequentially includes a first single mode fiber 211, a first collimating lens 212, and a first focusing lens 213.

The input light field Lin come from a laser (not shown) passes through the first single mode fiber 211 to form a divergent Gaussian beam, and further passes through the first collimating lens 212 to form a parallel Gaussian beam. Then, the parallel Gaussian beam passes through the first focusing lens 213 to form a focused beam suitable for a mode of the resonant cavity C.

As shown in FIG. 4, the light incident assembly 210 further includes a focus adjusting mechanism 214 of the input light field Lin, and the first single mode fiber 211, the first collimating lens 212 and the first focusing lens 213 are disposed on the focus adjusting mechanism 214, where the selections of a numerical aperture of the first single mode fiber 211, focal length of the first collimating lens 212, and focal length of the first focusing lens 213 are used for adjusting a focus size of the input light field Lin.

It should be noticed that the first collimating lens 212 is disposed in a rotation platform 214a of the focus adjusting mechanism 214, and the first focusing lens 213 is disposed in a lens sleeve shown in FIG. 4. The focus adjusting mechanism 214 can be used to adjust a focus position of the input light field Lin to achieve a better transmission of the main frequency range, and achieve a better extinction ratio of the sub-frequency range. Moreover, the optimal focus size of the input light field Lin can be functions of a lens curvature and a thickness of the lens body 110a of the optical filtering element 110, and a wavelength of the input light field Lin, which can be suitably adjusted according to an actual requirement.

In an embodiment of the disclosure, the focus adjusting mechanism 214 of the input light field Lin may include a rotation platform 214a and a translation platform 214b used for adjusting the focus position of the input light field Lin. The rotation platform 214a can be rotated on a two-dimensional plane, and the translation platform 214b can be moved in parallel in a three-dimensional space.

Referring to FIG. 4, the focused light beam suitable for the mode of the resonant cavity C is continually propagated along the optical axis Ox to enter the aforementioned tunable optical filter 100, and the focused light beam is filtered according to a method as that described in the embodiment of FIG. 3, and details thereof are not repeated.

In the tunable optical filter module 200, along a direction from the upstream end to the downstream end of the optical axis Ox, the light receiving assembly 220 sequentially includes a first mirror 221, a second mirror 222, a second focusing lens 223, a second collimating lens 224, and a second single mode fiber 225. As shown in FIG. 4, the light passing through the tunable optical filter 100 is gradually divergent, and after an optical path is changed by the first mirror 221 and the second mirror 222 and collimation of the optical path is adjusted, the divergent light passes through the second focusing lens 223 and is changed to a parallel light beam. The parallel light beam further passes through the second collimating lens 224 to adjust the focus size of the light beam and a numerical aperture of the light beam. Finally, the light beam enters the second single mode fiber 225 for the detection. The light receiving assembly 220 can maintain the high transmission of the main frequency range (a fiber collection efficiency of the main frequency may reach 65%), and achieve 10-times attenuation of the sub-frequency range.

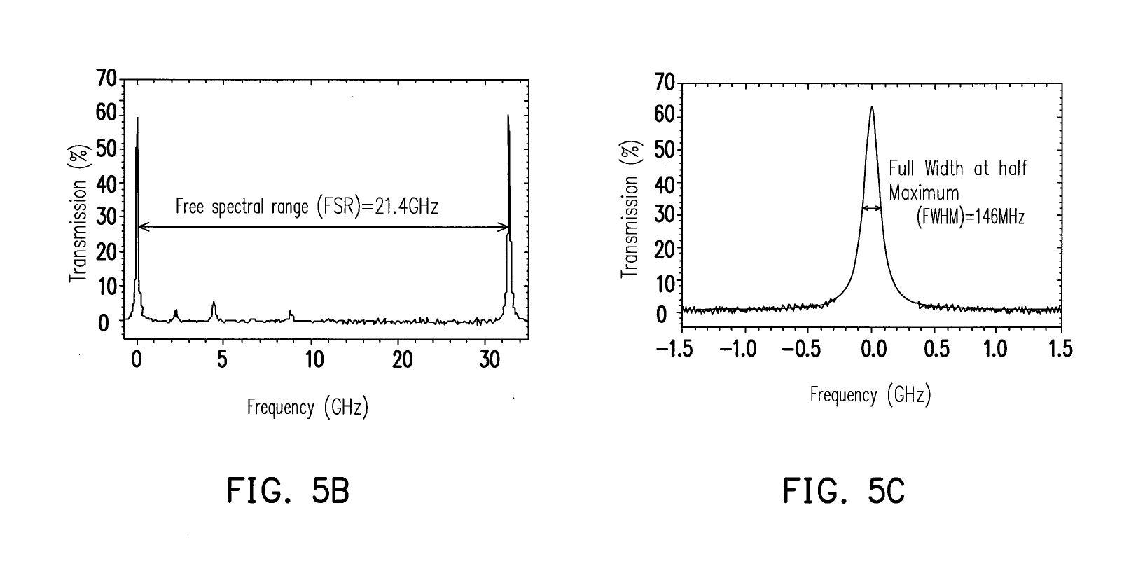

FIG. 5A is a spectrum diagram of the input light field passing through the tunable optical filter and passing through the light receiving assembly. Referring to FIG. 5A, a zero point of frequency is defined as the best light transmission (the main frequency), a curve 310 represents the signals detected behind the second single mode fiber 225, and a curve 320 represents the signals detected behind the tunable optical filter 100. According to FIG. 5A, it is known that when the second focusing lens 223, the second collimating lens 224, and the second single mode fiber 225 are used to receive the light field, a light collection efficiency of the main frequency (the fiber collection efficiency) may reach 65%, and attenuation of the sub frequency is increased by 10 dB. Moreover, when the light receiving assembly 210, the tunable optical filter 100 and the light receiving assembly 220 are combined, a main-frequency transmission of 40% is achieved, and sub-frequency attenuation of more than 40 dB is achieved.

FIG. 5B is a spectrum diagram of free spectrum range. FIG. 5C is a spectrum diagram of the FWHM of the main frequency. According to FIG. 5B, it is known that the free spectrum range is 21.4 GHz, and according to FIG. 5C, it is known that the FWHM of the main frequency is 146 MHz. Therefore, the bandwidth of the tunable optical filter 100 of the disclosure can be thousands times narrower than the bandpass filter sold in the market.

The tunable optical filter module 200 composed of the light incident assembly 210, the tunable optical filter 100 and the light receiving assembly 220 may have the main-frequency transmission of 40% and the sub-frequency attenuation of more than 40 dB. Moreover, the attenuated power of the main frequency can be compensated through a power amplifier.

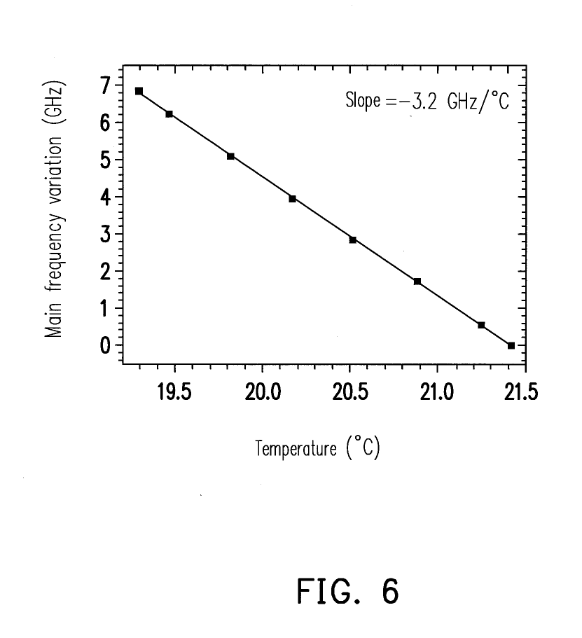

FIG. 6 is a schematic diagram of a linear relationship between the main frequency and temperature. The tunable optical filter 100 of the present embodiment can adjust the main frequency by simply controlling the temperature. According to FIG. 6, it is known that a slope of the main frequency variation (GHz) relative to the temperature (° C.) is −3.2 GHz/° C. Namely, when the temperature of the tunable optical filter 100 is adjusted by 1° C., the main frequency variation is −3.2 GHz.

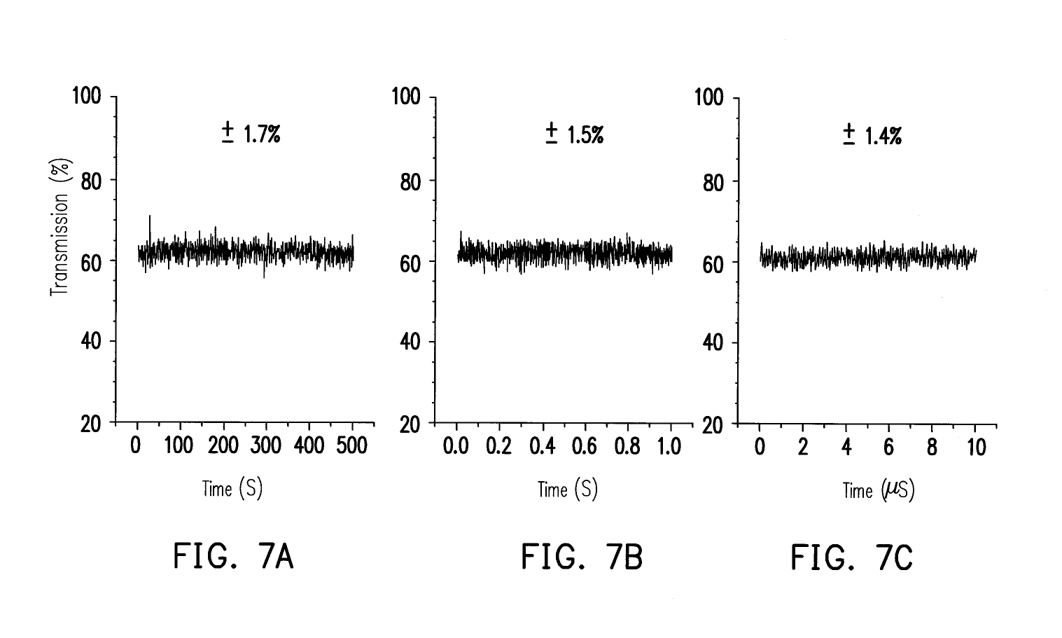

FIG. 7A is a schematic diagram of intensity (transmission) fluctuation of the output light field within 8 minutes. FIG. 7B is a schematic diagram of intensity (transmission) fluctuation of the output light field within 1 second. FIG. 7C is a schematic diagram of intensity (transmission) fluctuation of the output light field within 10 microseconds. Referring to FIG. 7A-FIG. 7C, it is known that even if under different time periods (8 minutes, 1 second, and 10 microseconds), since a temperature range of the tunable optical filter 100 is close to a room temperature, the temperature controlling assembly 120 can reduce a temperature fluctuation to be lower than ±3 mK, and a fluctuation of the light intensity (the transmission) of the main frequency that passes through the tunable optical filter 100 is smaller than ±2%. Namely, good frequency stability is achieved.

In the tunable optical filter of the disclosure, the light beam only passes through the double-side coated optical filtering element 110 for once, and the temperature controlling assembly 120 is used to control the cavity length L of the resonant cavity C of the optical filtering element 110. A high transmission (60%) of the main frequency and high attenuation (30 dB) of the sub-frequency range are achieved.

In this way, a rather narrow bandwidth (150 MHz) of the main frequency is obtained. The tunable optical filter is greatly increased the application in optical communication. Moreover, the temperature controlling assembly 120 can precisely control the cavity length L of the resonant cavity C, and temperature stability is ±0.001° C., such that a fluctuation of the light intensity (the transmission) is smaller than ±2% (shown in FIG. 7A-FIG. 7C), and the corresponding frequency fluctuation is smaller than ±10 MHz.

Based on the optical structure of the tunable optical filter module 200, the light collection efficiency of the main frequency range is improved, and attenuation of the sub-frequency range is enhanced. Moreover, a modular design method can be applied to the tunable optical filter module 200 of the disclosure.

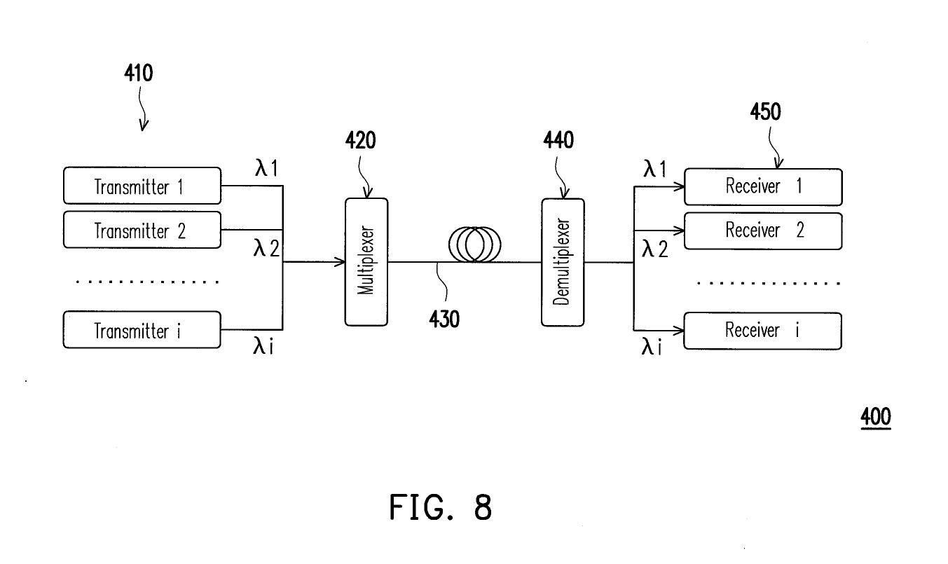

FIG. 8 is a schematic diagram of an optical communication system using the tunable optical filter of the disclosure as a demultiplexer. Referring to FIG. 8, the optical communication system 400 includes transmitters 410, a multiplexer 420, a fiber transmission network 430, a demultiplexer 440 and receivers 450. The tunable optical filter 100 provided by the disclosure can serve as the demultiplexer 440 to cut a full bandwidth into a plurality of channels with equal bandwidths. Since the tunable optical filter 100 has a rather narrow bandwidth (150 MHz), i.e. has a good frequency cutting capability, more channels can be provided to more subscribers, and a cross-talk phenomenon is greatly decreased.

In summary, in the tunable optical filter and the tunable optical filter module of the disclosure, the cavity length of the resonant cavity of the double-side coated optical filtering element is adjusted through temperature control, so as to select the main frequency, and accordingly achieve characteristics of narrow bandwidth, good frequency stability, high transmission of the main frequency and high attenuation of the sub-frequency range. Moreover, the tunable optical filter has high flexibility, namely, the main frequency range, the filtering frequency and the attenuation of the sub-frequency range can all be adjusted. In addition, the tunable optical filter may adopt a modular design to achieve high technique scalability.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed:

1. A tunable optical filter, having an optical axis, wherein an input light field moves forward from an upstream end to a downstream end of the optical axis, and passes through the tunable optical filter to form an output light field, the input light field has a main frequency range and a sub-frequency range, and the output light field has the main frequency range, the tunable optical filter comprising:
an optical filtering element, having a lens body, a first coating film and a second coating film, wherein the first coating film and the second coating film are respectively disposed on a first surface and a second surface of the lens body opposite to each other, and a resonant cavity with a cavity length is formed inside the lens body; and
a temperature controlling assembly, thermally connected with the optical filtering element, wherein the temperature controlling assembly controls the temperature of the optical filtering element to adjust the cavity length, so as to select the main frequency range.

2. The tunable optical filter as claimed in claim 1, wherein along a direction from the upstream end to the downstream end of the optical axis, the temperature controlling assembly sequentially comprises a heat dissipation structure, a temperature control chip, a thermal conduction body, a thermal conduction cover, and a light shielding cover, wherein
the thermal conduction body has a space for accommodating the optical filtering element, and
the optical filtering element is disposed between the thermal conduction body and the thermal conduction cover.

3. The tunable optical filter as claimed in claim 2, further comprising:
a thermal conduction medium, disposed between the optical filtering element, the thermal conduction body and the thermal conduction cover.

4. The tunable optical filter as claimed in claim 2, wherein the thermal conduction body has at least one thermistor.

5. The tunable optical filter as claimed in claim 2, wherein the heat dissipation structure, the temperature control chip, the thermal conduction body, the thermal conduction cover, and the light shielding cover respectively have a hole at a central portion,
such that the input light field is capable of moving forward along the optical axis to pass through the optical filtering element to form the output light field.

6. The tunable optical filter as claimed in claim 1, further comprising:
a base, wherein the optical filtering element and the temperature controlling assembly are disposed on the base.

7. A tunable optical filter module, comprising:
a tunable optical filter, having an optical axis, wherein an input light field moves forward from an upstream end to a downstream end of the optical axis, and passes through the tunable optical filter to form an output light field, the input light field has a main frequency range and a sub-frequency range, the output light field has the main frequency range, and the tunable optical filter comprises:
an optical filtering element, having a lens body, a first coating film and a second coating film, wherein the first coating film and the second coating film are respectively disposed on a first surface and a second surface of the lens body opposite to each other, and a resonant cavity with a cavity length is formed inside the lens body; and
a temperature controlling assembly, thermally connected with the optical filtering element, wherein the temperature controlling assembly controls a temperature of the optical filtering element to adjust the cavity length, so as to select the main frequency range;
a light incident assembly, disposed on the optical axis, and guiding the input light field to enter the tunable optical filter; and
a light receiving assembly, disposed on the optical axis, and receiving the output light field from the tunable optical filter.

8. The tunable optical filter module as claimed in claim 7, wherein along a direction from the upstream end to the downstream end of the optical axis, the temperature controlling assembly sequentially comprises a heat dissipation structure, a temperature control chip, a thermal conduction body, a thermal conduction cover and a light shielding cover, wherein
the thermal conduction body has a space for accommodating the optical filtering element, and
the optical filtering element is disposed between the thermal conduction body and the thermal conduction cover.

9. The tunable optical filter module as claimed in claim 8, further comprising:
a thermal conduction medium, disposed between the optical filtering element, the thermal conduction body, and the thermal conduction cover.

10. The tunable optical filter module as claimed in claim 8, wherein the thermal conduction body has at least one thermistor.

11. The tunable optical filter module as claimed in claim 8, wherein the heat dissipation structure, the temperature control chip, the thermal conduction body, the thermal conduction cover, and the light shielding cover respectively have a hole at a central portion,
such that the input light field is capable of moving forward along the optical axis to pass through the optical filtering element to form the output light field.

12. The tunable optical filter module as claimed in claim 7, further comprising:
a base, wherein the optical filtering element and the temperature controlling assembly are disposed on the base.

13. The tunable optical filter module as claimed in claim 7, wherein along a direction from the upstream end to the downstream end of the optical axis, the light incident assembly sequentially comprises:
a first single mode fiber, a first collimating lens, and a first focusing lens.

14. The tunable optical filter module as claimed in claim 13, wherein the light incident assembly further comprises:
a focus adjusting mechanism of the input light field,
wherein the first single mode fiber, the first collimating lens, and the first focusing lens are disposed on the focus adjusting mechanism of the input light field,
wherein the selections of a numerical aperture of the first single mode fiber, focal length of the first collimating lens, and focal length of the first focusing lens are used for adjusting a focus size of the input light field.

15. The tunable optical filter module as claimed in claim 14, wherein the focus adjusting mechanism of the input light field comprises:
a rotation platform and a translation platform, adjusting a focus position of the input light field.

16. The tunable optical filter module as claimed in claim 7, wherein along a direction from the upstream end to the downstream end of the optical axis, the light receiving assembly sequentially comprises:
a first mirror, a second mirror, a second focusing lens, a second collimating lens, and a second single mode fiber.
